(19) United States
(12) Patent Application Publication
(10) Pub. No.: US 2017/0257762 A1
(43) Pub. Date: Sep. 7, 2017

(54) METHODS AND NODES IN A WIRELESS COMMUNICATION NETWORK

(71) Applicant: Huawei Technologies Co., Ltd., Shenzhen (CN)

(72) Inventors: Philip Ginzboorg, Helsinki (FI); Kari Juhani Leppanen, Helsinki (FI)

(21) Appl. No.: 15/599,855

(22) Filed: May 19, 2017

Related U.S. Application Data
(63) Continuation of application No. PCT/EP2014/075185, filed on Nov. 20, 2014.

(51) Int. Cl. H04W 12/06; G06F 21/44

(52) U.S. Cl. CPC H04W 12/06; G06F 21/44; H04W 74/006

(57) ABSTRACT

A node and a method therein, for authenticating a mobile device over an air interface. The node comprises a transmitter, a processor, and a receiver. The processor is configured to detect the mobile device, to generate a nonce, to determine a key shared with the mobile device and to compute a second MAC based on the generated nonce and the key, and to construct a second training sequence comprising the second MAC. The transmitter is configured to transmit the generated nonce to the mobile device. The receiver is configured to receive a first training sequence comprising a first MAC from the mobile device and to tune the receiving circuits of the receiver, based on the first and second training sequences; and to receive a further message from the mobile device. Further, the processor is configured to decode the further message and authenticate the mobile device or reject the mobile device.

### CROSS-REFERENCE TO RELATED APPLICATIONS

This application is a continuation of International Application No. PCT/EP2014/075185, filed on Nov. 20, 2014, the disclosure of which is hereby incorporated by reference in its entirety.

### TECHNICAL FIELD

Implementations described herein generally relate to a node, a mobile device and methods therein. In particular, a mechanism is herein described, for authenticating a mobile device over an air interface.

In wireless communication networks there are various mobile devices; for example mobile telephones but also other, possibly smaller mobile devices comprising mobile sensors and wearable computing devices having radio communication ability, such as e.g. eyeglasses, watch, key, wallet, entrance cards, devices integrated into the user's cloths and/or shoes, implants for medical purposes etc. The enumerated items are merely some arbitrary examples of such devices, not an exhaustive listing. These relatively simple mobile devices with limited battery power may need to be authenticated towards a node of the mobile network infrastructure, or towards another mobile device. Also, the mobile device has to transmit radio signals in order for the network node to estimate the quality of the radio transmission channel between the network node and the mobile device.

However, due to size limitations of such mobile device, the energy stored in the batteries of those devices may be rather small, having limited capacity.

It is thus desired to authenticate mobile devices towards the wireless communication network, or a node thereof, in an energy-efficient manner.

From an energy-efficiency view point, it is desirable to introduce new mechanisms for authenticating mobile devices towards the wireless communication network, or a node thereof, but not compromising security while reducing energy consumption.

### SUMMARY

It is therefore an object to obviate at least some of the above mentioned disadvantages and to authenticate a mobile device over a wireless communication interface.

This and other objects are achieved by the features of the appended independent claims. Further implementation forms are apparent from the dependent claims, the description and the figures.

According to a first aspect, a node is provided, for authenticating a mobile device over an air interface. The node comprises a transmitter, a processor and a receiver. The processor is configured to detect the mobile device. Also, the processor is configured to generate a nonce and to determine a cryptographic key which is shared with the mobile device. Furthermore, the processor is configured to compute a second message authentication code based on the generated nonce and the cryptographic key, and to construct a second training sequence comprising the second message authentication code. The transmitter is configured to transmit the generated nonce to the mobile device. The receiver is configured to receive a first training sequence comprising a first message authentication code from the mobile device and to tune the receiving circuits of the receiver, based on the received first training sequence and the constructed second training sequence. The receiver is further configured to receive a further message from the mobile device after tuning the receiving circuits of the receiver. In addition, the processor is further configured to decode the further message and to authenticate the mobile device when the further message is decoded correctly, otherwise reject the mobile device.

By combining, or mixing, authentication based on a Message Authentication Code (MAC), with the training sequence for the purpose of channel estimation, energy savings are enabled both at the node and the mobile device. This is important, in particular for the mobile device as battery operating time is critical for the mobile device, as for most portable electronic equipment, due to user demands of high portability/slim design, which put a limit on battery size and thereby also battery capacity of the mobile device. Reducing energy consumption at the mobile device side according to the disclosed method thus extends the operating time of the mobile device, without losing any functionality.

Another advantage is the savings in radio resources. Since the training sequence is “self-authenticating,” there is no need to allocate time and frequency for sending a separate authentication message from the mobile device to the node.

In a first possible implementation of the node according to the first aspect, the processor may also be configured to perform a channel estimation based on the received first training sequence and the constructed second training sequence and wherein the receiver is configured to tune the receiving circuits based on the channel estimation.

It is thereby clarified how the channel estimation may be performed. By using the message authentication code for radio channel estimation it is enabled to perform part of the authentication procedure in parallel with the channel estimation, instead of sequentially as in legacy methods. Thereby time is saved and the mobile device may access the network faster than according to legacy methods, leading to improved user experience.

In a second possible implementation of the node according to the first aspect, or the first possible implementation of the first aspect, the authentication of the mobile device may be repeated periodically.

By repeating the authentication periodically, security is enhanced as the risk for a non-authorised device to get access to the node is reduced.

In a third possible implementation of the node according to the first aspect, or any of the previous possible implementations of the first aspect, the transmitter may be further configured to transmit a node identification reference of the node to the mobile device.

By transmitting the node identification reference of the node e.g. together with the generated nonce, the receiving part, i.e. the mobile device, knows which cryptographic key to use for generating the message authentication code, as the mobile device may share cryptographic keys with several nodes. Further, other mobile devices in the vicinity, not having exchanged cryptographic keys with the node may ignore the challenge entirely and thereby save battery resources.

In a fourth possible implementation of the node according to the first aspect, or any of the previous possible implementations of the first aspect, the processor may be further configured detect a mobile device identification reference of the mobile device and to compute the second message authentication code based on the generated nonce, the node identification reference and the mobile device identification reference.

By computing the message authentication code not only on the generated nonce but also adding identification references of the node and the mobile device, security is enhanced.

In a fifth possible implementation of the node according to the first aspect, or any of the previous possible implementations of the first aspect, the receiver may further be configured to receive two or more first training sequences comprising the first message authentication code over at least two communication frames.

By enabling partition of the message authentication code into a plurality of parts at the transmitter side and performing corresponding partition on the receiver side, it is possible to provide the message authentication code also when it exceeds the length of the training sequence, which may be the case e.g. in some access technology standards, even if the processor actually does not need to reconstruct the authentication code from the received training sequence. Thus implementation in various technical environments is facilitated.

In a sixth possible implementation of the node according to the first aspect, or any of the previous possible implementations of the first aspect, the processor is further configured to instruct the mobile device to refresh cryptographic key to be used by the mobile device for generating the first message authentication code, and also configured to refresh cryptographic key to be used when generating the second message authentication code.

Thereby, the problem of regeneration of shared cryptographic keys in a coordinated manner is solved. Also, by enabling frequent regeneration of shared cryptographic keys, security is enhanced, since using the same cryptographic key for a large amount of data may make some cryptographic attacks easier.

In a seventh possible implementation of the node according to the first aspect, or any of the previous possible implementations of the first aspect, the node further comprises an adaptive equaliser with a cryptographic protocol module and a training sequence generator, wherein the training sequence generator may take a part, or all of its input from the cryptographic protocol module for constructing the second training sequence.

Thereby, a convenient and operationally reliable implementation of the first aspect is enabled.

According to a second aspect, a method is provided, for use in a node. The method aims at authenticating a mobile device over an air interface. The method comprises detecting a mobile device. Further, the method comprises transmitting a message comprising a generated nonce. Also, the method comprises determining a cryptographic key, which is shared with the detected mobile device. The method furthermore comprises computing a second message authentication code, based on the generated nonce and the determined cryptographic key. In addition the method further comprises constructing a second training sequence comprising the second message authentication code. Also, the method comprises receiving a first training sequence from the mobile device, comprising a first message authentication code. Furthermore, the method also comprises tuning the receiving circuits of the receiver, based on the received first training sequence and the constructed second training sequence. The method also comprises receiving a further message from the mobile device. Additionally the method further comprises decoding the further message received from the mobile device. The method comprises authenticating the mobile device when the further message is decoded correctly, otherwise rejecting the mobile device.

By combining, or mixing, authentication based on a MAC, with a training sequence for the purpose of channel estimation, energy savings are enabled both at the node and the mobile device. This is important, in particular for the mobile device as battery operating time is critical for the mobile device, as for most portable electronic equipment, due to user demands of high portability/slim design, which put a limit on battery size and thereby also battery capacity of the mobile device. Reducing energy consumption at the mobile device side according to the disclosed method thus extends the operating time of the mobile device, without losing any functionality.

Another advantage is the savings in radio resources. Since the training sequence is “self-authenticating,” there is no need to allocate time and frequency for sending a separate authentication message from the mobile device to the node.

In a first possible implementation of the method according to the second aspect, the method also comprises tuning the receiving circuits of the receiver, comprising a channel estimation based on the received first training sequence and the constructed second training sequence.

By using the message authentication code for radio channel estimation it is enabled to perform part of authentication procedure in parallel with the channel estimation, instead of sequentially as in legacy methods. Thereby time is saved and the mobile device may access the network faster than according to legacy methods, leading to improved user experience.

In a second possible implementation of the method according to the second aspect, or the first possible implementation of the second aspect, the authentication according to at least some of the performed actions may be repeated periodically.

By repeating the authentication periodically, security is enhanced as the risk for a non-authorised device to get access to the node is reduced.

In a third possible implementation of the method according to the second aspect, or any of the previous possible implementations of the second aspect, the transmitted message further may comprise a node identification reference of the node.

By transmitting the node identification reference of the node e.g. together with the generated nonce, the receiving part, i.e. the mobile device, knows which cryptographic key to use for generating the message authentication code, as the mobile device may share cryptographic keys with several nodes. In addition, other mobile devices in the vicinity, not having exchanged cryptographic keys with the node may ignore the challenge entirely and thereby save battery resources.

In a fourth possible implementation of the method according to the second aspect, or any of the previous possible implementations of the second aspect, a mobile device identification reference of the mobile device may be detected and wherein the second message authentication code may be computed based on the generated nonce, the node identification reference and the mobile device identification reference.

By computing the message authentication code not only on the generated nonce but also adding identification references of the node and the mobile device, security is enhanced.

In a fifth possible implementation of the method according to the second aspect, or any of the previous possible implementations of the second aspect, the two or more first training sequences comprising the first message authentication code may be received over at least two communication frames.

By enabling partition of the message authentication code into a plurality of parts at the transmitter side and perform corresponding partition on the receiver side, it is possible to provide the message authentication code also when it exceeds the length of the training sequence, which may be the case e.g. in some access technology standards. Thus implementation in various technical environments is facilitated.

In a sixth possible implementation of the method according to the second aspect, or any of the previous possible implementations of the second aspect, the method may comprise transmitting an instruction to the mobile device, to refresh cryptographic key to be used by the mobile device for generating the first message authentication code, and wherein the method also may comprise refreshing cryptographic key to be used when generating the second message authentication code.

Thereby, the problem of regeneration of shared cryptographic keys in a coordinated manner is solved. Also, by enabling frequent regeneration of shared cryptographic keys, security is enhanced since using the same cryptographic key for a large amount of data may make some cryptographic attacks easier.

In a seventh possible implementation of the method according to the second aspect, or any of the previous possible implementations of the second aspect, the construction of the second training sequence may be made by a training sequence generator comprised in the node, taking a part, or all of its input from the cryptographic protocol module, also comprised in the node.

Thereby, a convenient and operationally reliable implementation of the second aspect is enabled.

According to a third aspect, a computer program is provided, comprising a program code for performing a method according to the second aspect, or any of the previous possible implementations of the second aspect, when the computer program runs on a computer.

By combining, or mixing, authentication based on a MAC, with a training sequence for the purpose of channel estimation, energy savings are enabled both at the node and the mobile device. This is important, in particular for the mobile device as battery operating time is critical for the mobile device, as for most portable electronic equipment, due to user demands of high portability/slim design, which put a limit on battery size and thereby also battery capacity of the mobile device. Reducing energy consumption at the mobile device side according to the disclosed method thus extends the operating time of the mobile device, without losing any functionality.

Another advantage is the savings in radio resources. Since the training sequence is “self-authenticating,” there is no need to allocate time and frequency for sending a separate authentication message from the mobile device to the node.

Also, as at least a part of the authentication procedure and the channel estimation may be performed in parallel, instead of sequentially as in legacy methods, time is saved and the mobile device may access the network faster than according to legacy methods, leading to improved user experience.

According to a fourth aspect, a mobile device is provided, for providing authentication of the mobile device to a node over an air interface. The mobile device comprises a receiver, configured to receive a message comprising a nonce, from the node. Further, the mobile device comprises a processor, configured to determine a cryptographic key, which is shared with the node. The processor is also configured to compute a first message authentication code based on the received nonce and on the determined cryptographic key. The processor is also configured to construct a first training sequence comprising the computed first message authentication code. In addition, the mobile device comprises a transmitter configured to transmit a message comprising an identity reference to the mobile device. The transmitter is also configured to transmit the first training sequence and subsequently a further message, to be received by the node.

By combining, or mixing, authentication based on a MAC, with a training sequence for the purpose of channel estimation, energy savings are enabled both at the node and the mobile device. This is important, in particular for the mobile device as battery operating time is critical for the mobile device, as for most portable electronic equipment, due to user demands of high portability/slim design, which put a limit on battery size and thereby also battery capacity of the mobile device. Reducing energy consumption at the mobile device side according to the disclosed method thus extends the operating time of the mobile device, without losing any functionality.

Another advantage is the savings in radio resources. Since the training sequence is “self-authenticating,” there is no need to allocate time and frequency for sending a separate authentication message from the mobile device to the node.

Also, as at least a part of the authentication procedure and the channel estimation may be performed in parallel, instead of sequentially as in legacy methods, time is saved and the mobile device may access the network faster than according to legacy methods, leading to improved user experience.

In a first possible implementation of the mobile device according to the fourth aspect, the message received from the node may comprise the nonce, a node identification reference and a mobile device identification reference and wherein processor is configured to compute the first message authentication code based on the received nonce, the node identification reference and the mobile device identification reference.

By computing the message authentication code not only on the generated nonce but also adding identification references of the node and the mobile device, security is enhanced.

In a second possible implementation of the mobile device according to the fourth aspect, or the first possible implementation of the fourth aspect, the processor may be configured to divide the first message authentication code into a plurality of separate parts when the length of the first message authentication code exceeds the length of the first training sequence and distribute the separate parts of the first message authentication code over at least two communication frames.

By dividing the message authentication code into a plurality of parts at the transmitter side and perform corresponding reassembling on the receiver side, it is possible to provide the message authentication code also when it is longer than the length of the training sequence, which may be the case e.g. in some access technology standards. Thus implementation in various technical environments is facilitated.

In a third possible implementation of the mobile device according to the fourth aspect, or any previous possible implementation of the fourth aspect, the processor may be configured to distribute the divided first message authentication code by not putting the shortest of the separate parts in the ending communication frame of the at least two communication frames. In other words, the shortest of the separate parts is put in a communication frame being different from the ending one (i.e. the one sent out last).

By not placing the shortest of the separate parts in the ending communication frame when transmitting the first training sequence, it becomes more difficult for an eavesdropper to, when having received the penultimate communication frame, guess the content of the last communication frame (which in an extreme case may comprise one single bit), and perform e.g. a man-in-the-middle-attack. Thereby security is enhanced.

In a fourth possible implementation of the mobile device according to the fourth aspect, or any previous possible implementation of the fourth aspect, the processor may be further configured to refresh cryptographic key to be used for generating the first message authentication code, upon receiving an instruction to refresh cryptographic key from the node.

Thereby, the problem of regeneration of shared cryptographic keys in a coordinated manner is solved. Also, by performing frequent regeneration of shared cryptographic keys, security is enhanced since using the same cryptographic key for a large amount of data may make some cryptographic attacks easier.

According to a fifth aspect, a method in a mobile device is provided, for providing authentication of the mobile device to a node over an air interface. The method comprises transmitting a message comprising a mobile device identity reference. Further, the method comprises receiving a message comprising a nonce, from the node. In addition, the method further comprises determining a cryptographic key, which is shared with the node. Also, the method comprises computing a first message authentication code based on the received nonce and on the determined cryptographic key. The method also comprises constructing a first training sequence comprising the computed first message authentication code. Furthermore, the method also comprises transmitting the constructed first training sequence, to be received by the node. The method also comprises transmitting a further message to the node.

By combining, or mixing, authentication based on a MAC, with a training sequence for the purpose of channel estimation, energy savings are enabled both at the node and the mobile device. This is important, in particular for the mobile device as battery operating time is critical for the mobile device, as for most portable electronic equipment, due to user demands of high portability/slim design, which put a limit on battery size and thereby also battery capacity of the mobile device. Reducing energy consumption at the mobile device side according to the disclosed method thus extends the operating time of the mobile device, without losing any functionality.

Another advantage is the savings in radio resources. Since the training sequence is “self-authenticating,” there is no need to allocate time and frequency for sending a separate authentication message from the mobile device to the node.

Also, as at least a part of the authentication procedure and the channel estimation may be performed in parallel, instead of sequentially as in legacy methods, time is saved and the mobile device may access the network faster than according to legacy methods, leading to improved user experience.

In a first possible implementation of the method according to the fifth aspect, the message received from the node may comprise the nonce, a node identification reference and a mobile device identification reference and wherein the first message authentication code may be computed on the received nonce, the node identification reference and the mobile device identification reference.

By computing the message authentication code not only on the generated nonce but also adding identification references of the node and the mobile device, security is enhanced.

In a second possible implementation of the method according to the fifth aspect, or the first possible implementation of the fifth aspect, the first message authentication code may be divided into a plurality of separate parts when the length of the first message authentication code exceeds the length of the first training sequence, and the separate parts of the first message authentication code may be distributed over at least two communication frames.

By dividing the message authentication code into a plurality of parts at the transmitter side and perform corresponding division on the receiver side, it is possible to provide the message authentication code also when it is longer than the length of the training sequence, which may be the case e.g. in some access technology standards. Thus implementation in various technical environments is facilitated.

In a third possible implementation of the method according to the fifth aspect, or any previous possible implementation of the fifth aspect, the divided first message authentication code may be distributed over the at least two communication frames by not putting the shortest of the separate parts in the ending communication frame of the at least two communication frames. In other words, the shortest of the separate parts is put in a communication frame not being the ending one.

By not placing the shortest of the separate parts in the ending communication frame when transmitting the first training sequence, it becomes more difficult for an eavesdropper to, when having received the penultimate communication frame, guess the content of the last communication frame (which in an extreme case may comprise one single bit), and perform e.g. a man-in-the-middle-attack. Thereby security is enhanced.

In a fourth possible implementation of the mobile device according to the fifth aspect, or any previous possible implementation of the fifth aspect, the method may comprise refreshing a cryptographic key to be used for generating the first message authentication code, upon receiving an instruction to refresh cryptographic key from the node.

Thereby, the problem of regeneration of shared cryptographic keys in a coordinated manner is solved. Also, by performing frequent regeneration of shared cryptographic keys, security is enhanced since using the same cryptographic key for a large amount of data may make some cryptographic attacks easier.

According to a sixth aspect, a computer program is provided, comprising a program code for performing a method according to the fifth aspect, or any possible implementation thereof, when the computer program runs on a computer.

By combining, or mixing, authentication based on a MAC, with a training sequence for the purpose of channel estimation, energy savings are enabled both at the node and the mobile device. This is important, in particular for the mobile device as battery operating time is critical for the mobile device, as for most portable electronic equipment, due to user demands of high portability/slim design, which put a limit on battery size and thereby also battery capacity of the mobile device. Reducing energy consumption at the mobile device side according to the disclosed method thus extends the operating time of the mobile device, without losing any functionality.

Another advantage is the savings in radio resources. Since the training sequence is “self-authenticating,” there is no need to allocate time and frequency for sending a separate authentication message from the mobile device to the node.

Also, as at least a part of the authentication procedure and the channel estimation may be performed in parallel, instead of sequentially as in legacy methods, time is saved and the mobile device may access the network faster than according to legacy methods, leading to improved user experience.

Thereby, energy is saved at the mobile device, which may prolong the battery activity time between re-charge. Also, the reduced signalling within the communication system generates less uplink interference within the system. Thereby an improved performance within the wireless communication network is provided.

Other objects, advantages and novel features of the described aspects will become apparent from the following detailed description.

### BRIEF DESCRIPTION OF THE DRAWINGS

Various embodiments are described in more detail with reference to attached drawings, illustrating examples in which:

FIG. 1A is a block diagram illustrating wireless communication according to some embodiments;

FIG. 1B is a block diagram illustrating wireless communication according to some embodiments;

FIG. 1C is a block diagram illustrating wireless communication according to some embodiments;

FIG. 2 is a combined block diagram and signalling scheme, depicting an authentication protocol according to some embodiments;

FIG. 3 is a block diagram illustrating an adaptive equalisation with an addition of a cryptographic protocol module according to an embodiment;

FIG. 4 is a block diagram illustrating an embodiment of subcarriers in a multi-carrier radio system.

FIG. 5 is a flow chart illustrating a method in a node according to an embodiment;

FIG. 6 is a block diagram illustrating a node according to an embodiment;

FIG. 7 is a flow chart illustrating a method in a mobile device according to an embodiment; and

FIG. 8 is a block diagram illustrating a mobile device according to an embodiment.

### DETAILED DESCRIPTION

Embodiments of the invention described herein are defined as a node, a method in a node, a mobile device and a method in a mobile device, which may be put into practice in the embodiments described below. These embodiments may, however, be exemplified and realised in many different forms and are not to be limited to the examples set forth herein; rather, these illustrative examples of embodiments are provided so that this disclosure will be thorough and complete.

Still other objects and features may become apparent from the following detailed description, considered in conjunction with the accompanying drawings. It is to be understood, however, that the drawings are designed solely for purposes of illustration and not as a definition of the limits of the herein disclosed embodiments, for which reference is to be made to the appended claims. Further, the drawings are not necessarily drawn to scale and, unless otherwise indicated, they are merely intended to conceptually illustrate the structures and procedures described herein.

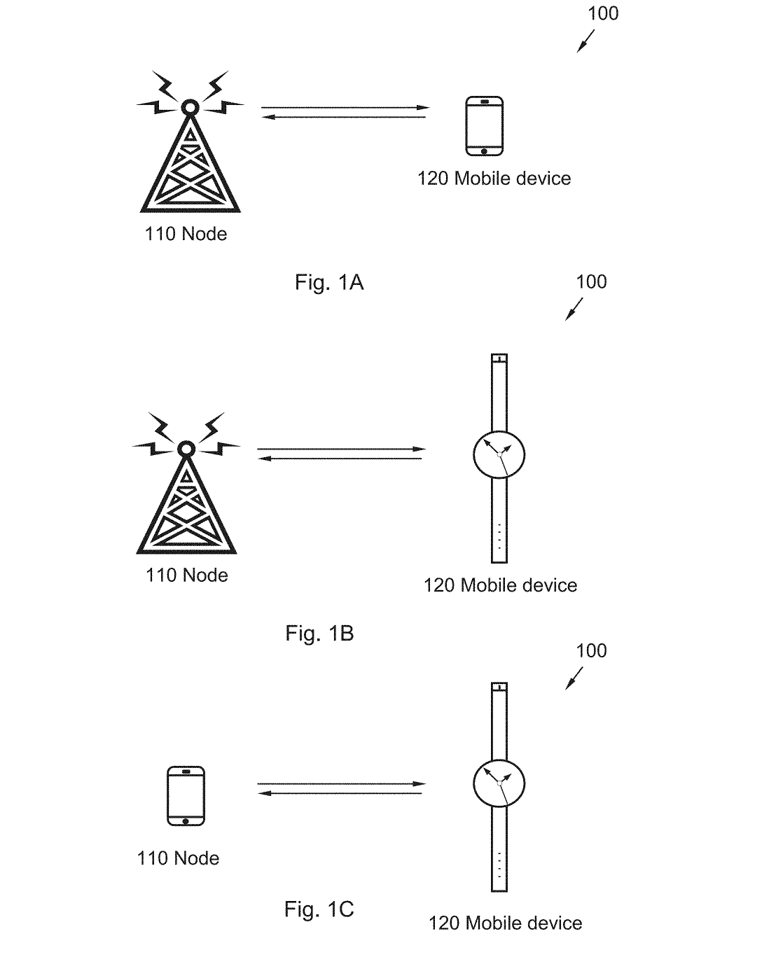

FIG. 1A is a schematic illustration over a wireless communication network 100 comprising a node 110 and a mobile device 120.

The wireless communication network 100 may at least partly be based on radio access technologies such as, e.g., 3rd Generation Partnership Project (3GPP) Long Term Evolution (LTE), LTE-Advanced, Evolved Universal Terrestrial Radio Access Network (E-UTRAN), Universal Mobile Telecommunications System (UMTS), Global System for Mobile Communications (originally: Groupe Special Mobile) (GSM)/Enhanced Data rate for GSM Evolution (GSM/EDGE), Wideband Code Division Multiple Access (WCDMA), Time Division Multiple Access (TDMA) networks, Frequency Division Multiple Access (FDMA) networks, Orthogonal FDMA (OFDMA) networks, Single-Carrier FDMA (SC-FDMA) networks, Worldwide Interoperability for Microwave Access (WiMax), or Ultra Mobile Broadband (UMB), High Speed Packet Access (HSPA) Evolved Universal Terrestrial Radio Access (E-UTRA), Universal Terrestrial Radio Access (UTRA), GSM EDGE Radio Access Network (GERAN), 3GPP2 CDMA technologies, e.g., CDMA2000 1×RTT and High Rate Packet Data (HRPD), Bluetooth, Near Field Communication (NFC), Wi-Fi, or similar, just to mention some few options. The expressions “wireless communication network”, “wireless communication system” and/or “cellular telecommunication system” may within the technological context of this disclosure sometimes be utilised interchangeably.

In the illustrated embodiment, the node 110 is represented by a network node, radio network node or base station, such as e.g., a Radio Base Station (RBS) or Base Transceiver Station (BTS), which in some networks may be referred to as eNB, “NodeB, NodeB or B-node, Access Point, pico base station, femto base station, beacon device, relay node, repeater or any other network node configured for communication with the mobile device 120 over a wireless interface, depending, e.g., of the radio access technology and/or terminology used.

The mobile device 120 may in this illustrated embodiment be represented by a mobile station also known as a User Equipment (UE), wireless terminal, mobile telephone, cellular telephone, computer tablet or laptop with wireless capability, etc.

The mobile device 120 in the present context may be, for example, portable, pocket-storable, hand-held, computer comprised, or vehicle-mounted mobile devices, enabled to communicate voice and/or data, via the node 110 and the wireless communication network 100.

The wireless communication network 100 may cover a geographical area which is divided into cell areas, with each cell area being served by a network node, such as the illustrated node 110.

Sometimes, the expression “cell” may be used for denoting the network node itself. How-ever, the cell may also in normal terminology be used for the geographical area where radio coverage is provided by the network node at a base station site. The node 110, situated on the base station site, may serve one or several cells. The node 110 may communicate over the air interface operating on radio frequencies with any mobile device 120 within range of the node 110.

It is to be noted that the illustrated network setting of one instance of the node 110 and one mobile device 120 in FIG. 1A is to be regarded as a non-limiting example of an embodiment only. The wireless communication network 100 may comprise any other number and/or combination of the discussed node 110 and/or mobile device 120. A plurality of mobile devices 120 and another configuration of nodes 110 may thus be involved in some embodiments of the disclosed invention.

Thus whenever “one” or “a” node 110 and/or mobile device 120 is referred to in the present context, a plurality of the node 110, and/or mobile device 120 may be involved, according to some embodiments.

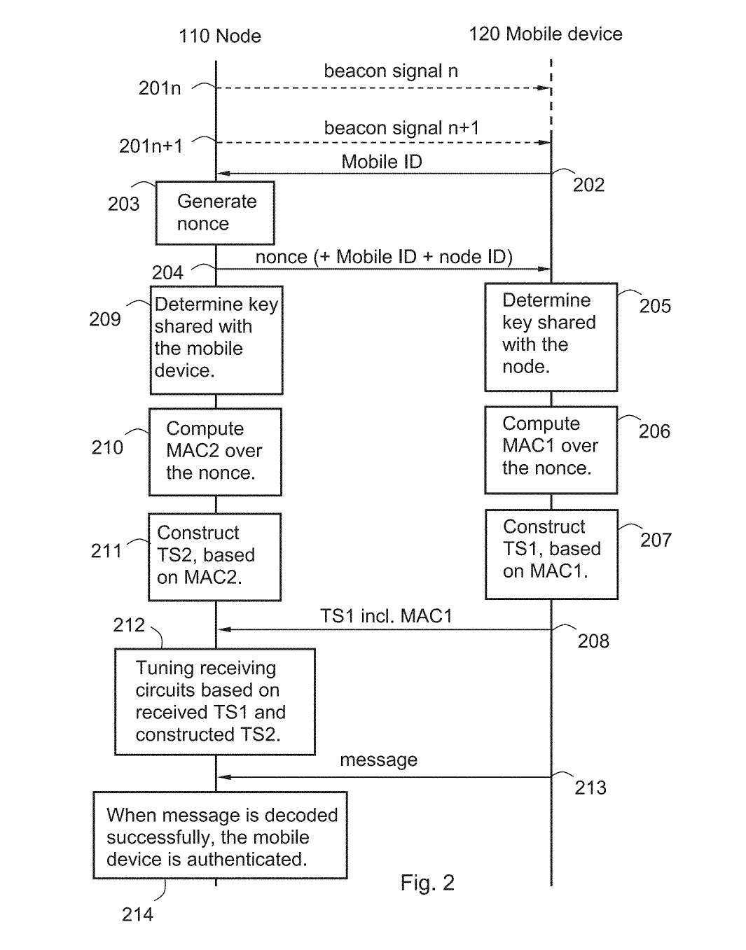

The purpose of the illustration in FIG. 1A is to provide a simplified, general overview of the wireless communication network 100 and the involved methods and nodes, such as the node 110 and the mobile device 120 herein described, and the functionalities involved. However, FIG. 1B and FIG. 1C illustrate alternative embodiments of the wireless communication network 100, while an embodiment of authentication according to the herein disclosed method is illustrated in FIG. 2.

In the embodiment illustrated in FIG. 1B, the node 110 may be identical with, or similar to, the node 110 illustrated in FIG. 1A while the mobile device 120 may comprise a mobile entity with radio communication ability but also limited battery power capacity, such as e.g. wearable computing devices, mobile sensors such as e.g. eyeglasses, watch, key, wallet, hearing aid, entrance card, public transportation ticket, devices integrated into the user's cloths and/or shoes, implant for medical purposes e.g. for monitoring and reporting body temperature, pulse, blood pressure etc., body implants, assault alarm, positioning device, game, media player or similar device. These are merely some examples of such mobile devices 120.

In the embodiment illustrated in FIG. 1C, the mobile device 120 may be identical with, or similar to, the mobile device 120 illustrated in FIG. 1B while the node 110 comprises a mobile entity such as e.g. a mobile station also known as a User Equipment (UE), wireless terminal, mobile telephone, cellular telephone, computer tablet or laptop with wireless capability, etc.

According to an embodiment, a training signal is transmitted by the mobile device 120 for the purpose of radio channel estimation and also for cryptographically authenticating the mobile device 120, towards the node 110. Thus the training signal becomes in itself a message that is part of cryptographic authentication protocol running between the parties.

An advantage of the method, to combine or mix authentication based on a Message Authentication Code (MAC), with a training sequence for the purpose of channel estimation, energy savings are enabled both at the node 110 and the mobile device 120. This is important, in particular for the mobile device 120 as battery operating time is critical for the mobile device 120, as for most portable electronic equipment, due to user demands of high portability/slim design, which put a limit on battery size and thereby also battery capacity of the mobile device 120. Reducing energy consumption at the mobile device side according to the disclosed method thus extends the operating time of the mobile device 120, without losing any functionality.

Also, as part of the authentication procedure and the channel estimation are performed at least partly in parallel, instead of sequentially as in legacy methods, time is saved and the mobile device 120 may access the network faster than according to legacy methods, leading to improved user experience.

FIG. 2 illustrates authentication of a mobile device 120 according to an embodiment. Firstly, some kind of initial communication and/or synchronisation between the node 110 and the mobile device 120 may be made. In order to enable the mobile device 120 to discover the node 110 and trigger signalling, the node 110 may transmit periodical beacon signals in a first optional action 201 n, where n may be an arbitrary integer. In a subsequent iteration of the beacon signal, 201 n+1, the mobile device 120 may have moved into radio range.

When the mobile device 120 receives such beacon signal from the node 110, it may initiate a join operation with the radio access network via the node 110. The node 110 and the mobile device 120 may be synchronised in time and frequency after the join operation. Thus, as a response to the beacon signal, the mobile device 120 may transmit a message for requesting access, comprising an Identification reference (ID) of the mobile device 120 in an action 202. However, in other embodiments, the mobile device 120 may transmit messages for requesting access e.g. with a predetermined periodicity, or when changing geographical location.

The node 110 and the mobile device 120 are sharing a cryptographic key, for example a symmetric key. That is, the node 110 and the mobile device 120 both have knowledge of an identical sequence of zeroes and ones that is kept secret and thus unknown for any third party. Thereby, it is possible for the node 110 to authenticate the mobile device 120, by verifying that the mobile device 120 indeed knows the secret key. This is done by transmitting a challenge (sometimes also referred to as nonce) to the mobile device 120, receiving a response from the mobile device 120 and comparing the response with an expected result, as will be further explained below.

According to an embodiment, the node 110 generates a nonce in action 203. The nonce may be a random number, a pseudo-random number, a non-repeatable number, a non-predictable number or similar. Typically, the nonce (and by the way also the shared cryptographic key of the authentication protocol) may be generated with a cryptographic pseudo-random number generator. The output of a cryptographic pseudo-random number generator should approximate a sequence of true random bits; and in addition it should be unpredictable and not be reused, in order to avoid a replay attack.

Having generated the nonce, the node 110 composes an authentication request message comprising the generated nonce. In some embodiments, also e.g. an Identity reference (ID) of the node 110 and/or ID of the mobile device 120 may be comprised, and transmit this message in action 204. The ID of the node 110 may be added in order for the mobile device 120 to know which node is transmitting the authentication request message. Thereby the mobile device 120 may reject the request, for example when no communication with the node 110 is desired. Also, by knowing the ID of the node 110, the mobile device 120 knows what cryptographic key to use for preparing the response, as different nodes may have different cryptographic keys shared with the mobile device 120. The ID of the mobile device 120 enables other mobile devices in the vicinity to neglect the authentication request message. However, the ID of the node 110 and/or ID of the mobile device 120 may be implicit within the message according to some alternative embodiments.

In some embodiments, the node 110 may indicate for the mobile device 120, e.g. in the message transmitted in action 204, that it expects to authenticate the mobile device 120 using the training sequence in a future transmission.

When the mobile device 120 receives the authentication request message, it may identify the node 110 having transmitted the message, based on the ID of the node 110 and determine the cryptographic key shared with the node 110 in action 205. Based on the extracted cryptographic key shared with the node 110, a (first) Message Authentication Code (MAC) may be computed over the received nonce, using a MAC algorithm in action 206. The MAC may sometimes be called “keyed hash function,” or “cryptographic checksum.” The MAC algorithm may be viewed as hash function which takes the nonce, or the received challenge comprising the nonce, and the shared cryptographic key as input parameters and produces a fixed-size output comprising e.g. 256, 160, or 128 bits. In some embodiments, the output of a standard MAC algorithm may be shortened such as e.g. truncated to the desired length, e.g. from 256 bits to 128 bits or any other arbitrary convenient length, when a shorter sequence is desired in the application.

Concerning the MAC algorithm, it is constructed so that (a) without knowing the secret key it is infeasible in practice to produce the same MAC; and (b) knowing the input message and the output MAC, it is infeasible in practice to compute the secret key.

Further, the MAC algorithm may be based on, or inspired by, a known standard such as e.g. ISO/IEC 9797-1 and -2, which define generic models and algorithms that may be used with any block cipher or hash function, and a variety of different parameters. Some non-limiting examples of MAC algorithms that may be used for generating the MAC according to the disclosed method comprises e.g. Hash Message Authentication Code (HMAC), One-key MAC (OMAC), Cipher Block Chaining MAC (CBC-MAC), Parallelisable MAC (PMAC), MAC based on Universal hashing (UMAC), VMAC, Message-Digest 5 (MD5), Secure Hash Algorithm (SHA) or similar.

Having computed the first message authentication code, here called MAC 1 in order to distinguish it, the mobile device 120 may embed the MAC 1 into a first Training Sequence (here called TS 1) in an action 207. The first training sequence, comprising the computed MAC 1 is then transmitted in action 208, from the mobile device 120 to be received by the node 110. This may be made in various ways in different embodiments, but firstly a brief explanation and discussion of the training sequence, or pilot signals as they also may be called, will be made.

The wireless channel between the node 110 and the mobile device 120 may initially be unknown and time-variant. Thus the node 110 and the mobile device 120 may be synchronised by transmission of a known sequence of bits, called training sequence. From the received signal and knowledge of the transmitted bit sequence, the node 110 may estimate the channel impulse response. The problem of time variance of the channel is solved by repeating the transmission of the training sequence at regular intervals, so that the radio circuits in the node 110 may regularly be adapted to the channel state. Since the channel state changes when the mobile device 120 moves, the degree of mobility that a radio system may support depends on how often the training sequence is transmitted.

For example, in the Orthogonal Frequency-Division Multiplexing (OFDM) method of encoding digital data on multiple carrier frequencies, a training OFDM symbol may be transmitted at the beginning of the data packet by the mobile device 120, to aid the Carrier Frequency Offset (CFO) estimations.

In sum, a training sequence is a preamble that precedes the transmitted data stream and is known to both the receiver and the transmitter; here: the node 110 and the mobile device 120 respectively. It therefore simplifies the problem of initial estimate of radio channel distortions. As a result the training sequence technique may be widely used within wireless communication networks 100. However, the training preamble does not convey any payload information. For example, the Global System for Mobile communications (GSM) uses 26 bits in the 148-bit frame for the training sequence, i.e. almost 18% of such frame cannot be used for payload.

Thereafter, having combined the first training sequence and MAC 1, the mobile device 120 may transmit the combined first training sequence and MAC 1, to be received by the node 110 in action 208. In other words, the mobile node 120 constructs the first training sequence such that it comprises the first message authentication code (MAC 1).

In parallel with the above described actions 205-208, the node 110 may determine the cryptographic key shared with the mobile device 120 in action 209. Using the determined cryptographic key, the node 110 may compute a second message authentication code (here called MAC 2) over the previously generated nonce, in action 210.

The computed MAC 2 may then be embedded into a second training sequence (TS 2) in action 211 by the node 110. This constructed second training sequence comprising the MAC 2 may be constructed in order to later be able to use it as a comparison with the received first training sequence, received from the mobile device 120 in action 212. Thus; when the node 110 receives the combined TS 1 and MAC 1 from the mobile device 120, i.e. the response to the previously transmitted challenge, a comparison may be made between the received MAC 1 and the locally computed MAC 2 by the node 110, using the shared cryptographic key, in action 212.

Please note that while estimating the channel distortions, the node 110 typically also adjusts its radio circuits to compensate for the estimated channel distortions in the subsequent communication. Those two operations may be termed as “tuning” of the radio circuits in the receiver of the node 110. Also the term “channel estimation” may be used for these two operations in the field of digital radio signal processing.

Typically, when the mobile device 120 has transmitted the response message, the first training sequence, in action 208, the mobile device 120 transmits a further message in action 213. This message and its transmission may be part of the authentication protocol. The message transmitted in action 213 may also contain data that the mobile device 120 wants to transmit to the node 110, or to some remote network entity through the node 110.

When the node 110, upon receiving the subsequently transmitted message from the mobile device 120 is able to correctly decode the received message, the node 110 may authenticate the mobile device 120, in action 214.

The reason is that, when only the node 110 and the mobile device 120 know the shared cryptographic key, and the received MAC 1 corresponds to the computed MAC 2, the node 110 with certainty could establish that the mobile device 120 actually is the mobile device 120, i.e. the transmitter of the message in action 208. The nonce ensures that the response message (comprising the MAC 1) was created after the firstly transmitted challenge.

However, in case the node 110 is not able to decode the further message received from the mobile device 120 in action 213, the mobile device 120 is not authenticated. Possibly, a new challenge may be transmitted to the mobile device 120 in some embodiments.

In some embodiments, a watch-dog timer may be started when the challenge is transmitted in action 204, and if the watch-dog timer times out before the response message is received from the mobile device 120, the mobile device 120 may be considered non-authorised. Thereby certain attacks by a third party may be avoided.

Further, it may be noticed that, since the MAC is computed based on the shared key, the contents of the response message by a legitimate mobile device 120 are known to the node 110. In other words, after having transmitted the challenge comprising the nonce in action 204, the node 110 knows exactly what to expect from the mobile device 120 in the response message of action 208. These properties of the authentication protocol and the training sequence are utilised by embedding the response message of action 208 into the first training sequence that the mobile device 120 sends to the node 110 for the purpose of radio channel estimation.

Further, according to some embodiments, the node 110 may perform channel estimation on the received combined first training sequence and MAC 1 in action 212. Channel estimation and/or signal quality may be based on e.g. Reference Signal Received Power (RSRP), Reference Signal Received Quality (RSRQ), Channel State Information (CSI), Channel Quality Indicators (CQI), Signal to Noise and Interference Ratio (SINR), Signal to Noise Ratio (SNR), Signal to Interference Ratio (SIR), Signal to Noise plus Interference Ratio (SNIR), or any other appropriate measurement reflecting the strength and/or quality of a signal, and/or a ratio between a certain desired signal and undesired interference or noise. Thereby, the node 110 may determine the received signal quality and estimate the channel.

This is based on the premise that the response message in action 208, which is a binary sequence computed with a cryptographic one-way function, has statistical properties which make it suitable also as training sequence for the radio channel. For example, no significant correlation is expected between bit sequences of different response messages.

It may also here be mentioned that the number of channel estimations per time unit typically exceeds the number of authentications needed per time unit within the wireless communication network 100.

Furthermore, it may be recalled that in at least some of the described embodiments, the training sequence comprises (or consists by itself of) the computed MAC. That training sequence is derived by the receiving node 110 in action 211 before it receives the response message from the mobile device 120 in action 208, and then used together with the training sequence part of the message received from the mobile device 120 in action 208, to tune the radio receiver of the node 110. Thus the node 110 knows if this tuning operation was done correctly, only if it successfully decodes additional data from the further message transmitted by the mobile device 120 in action 213. For that reason, the status of the mobile device's authentication towards the node 110 may still be undetermined immediately after it receives the first training sequence from the mobile device 120 in action 208. The authenticating party, i.e. the node 110, may determine that the authentication of the mobile device 120 succeeded, only if subsequent to the channel estimation in action 212, the node 110 successfully receives and decodes the further message from the mobile device 120 in action 213.

However estimating the uplink channel from the mobile device 120 to the node 110 may be required also in the conventional one-sided authentication. That uplink channel estimation must happen before the MAC 1 is transmitted from the mobile device 120 to the node 110 in the further message. Even though in the conventional one-sided authentication, the authenticating node 110 can determine if the authentication of the mobile device 120 succeeded (or not), immediately after it receives the MAC 1 in the first response message, the channel estimation time must be added to the total authentication time.

To conclude, in the typical situation, where the mobile device 120 sends a further message to the node 110 in action 213 immediately after the response message in action 208 containing the MAC 1, the total time that the node 110 needs to determine that authentication of the mobile device 120 succeeded with the procedure described in conjunction with FIG. 2, is unlikely to exceed the corresponding time needed by the conventional one-sided authentication procedure.

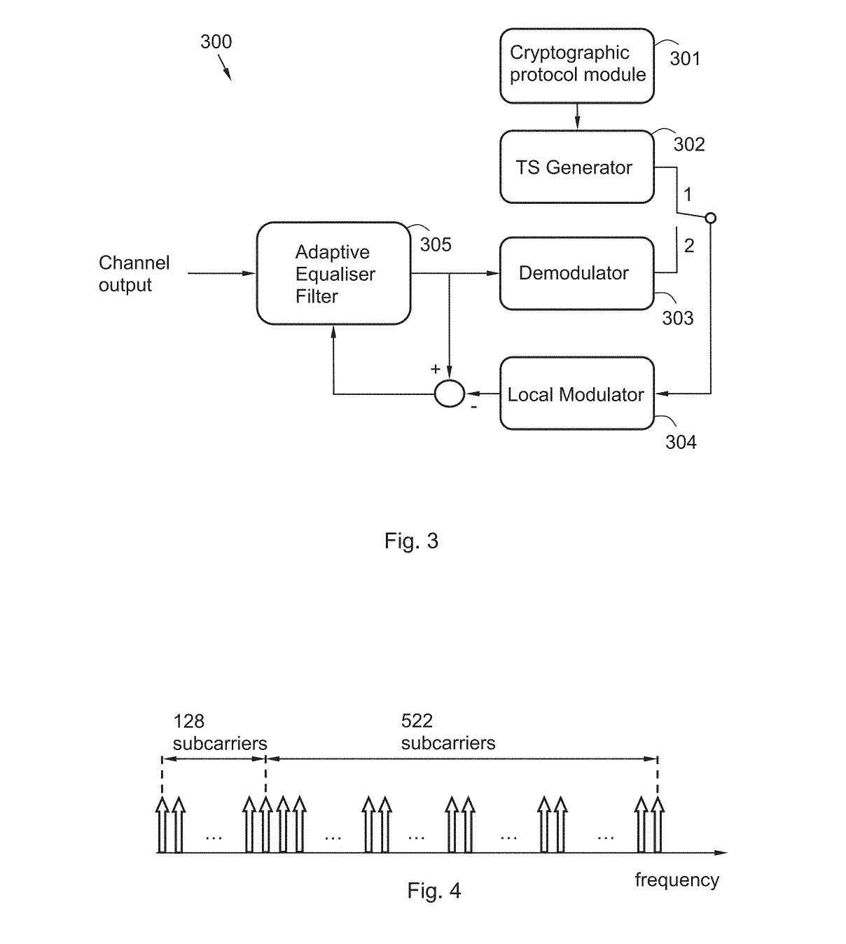

FIG. 3 schematically illustrates an adaptive equaliser 300 which may be part of the node 110 and an example of adaptive equalisation with an addition of a cryptographic protocol module 301 comprised in the adaptive equaliser 300.

The adaptive equaliser 300 automatically adapts to time-varying properties of the communication channel, mitigating the effects of e.g. multipath propagation and Doppler spreading.

The adaptive equaliser 300 according to an embodiment further comprises a cryptographic protocol module 301, a training sequence generator 302, a demodulator 303, a local modulator 304 and an adaptive equaliser filter 305. The training sequence generator 302 may take a part, or all of its input from the cryptographic protocol module 301.

The equaliser 300 may operate according to the following principle, in some embodiments. The difference between the output from the adaptive equaliser filter 305 and the output of the local modulator 304 is fed into the adaptive equaliser filter 305. This difference is ideally zero; and this objective is used in tuning the adaptive equaliser filter 305.

At the beginning of data transmission, the training sequence generator 302, may be connected to the input of the local modulator 304. In this situation the difference between the modulated training sequence and the output of the adaptive equaliser filter 305 is fed back into the adaptive equaliser filter 305. The adaptive equaliser filter 305 then tunes its circuits (e.g. the receiving circuits of the receiver of the node 110) so that this difference becomes as small as possible.

After the circuits of the adaptive equaliser filter 305 (e.g. the receiving circuits of the receiver of the node 110) have been tuned in this manner, the training sequence generator 302 may be disconnected from the local modulator 304. Instead, the local modulator 304 may take its input from the demodulator 303. In this situation the tuning of the adaptive equaliser filter 305 may still continue, but it is based on the difference between the equalised signal and a replica of that (same) signal which has been reconstructed from the demodulator 303 output.

Some alternative embodiments will subsequently be discussed and explained more in detail. The generated nonce at the node 110 may be transmitted towards the mobile device 120 by means of beam forming in some embodiments. Thereby, the challenge may be transmitted to the specific mobile device 120, generating reduced interference for other radio communication equipment in the vicinity.

Also, the challenge may comprise an instruction to the mobile device 120 to refresh authentication keys and possibly also other cryptographic keys, like the keys used for integrity protection and encryption. The mobile device 120 may then use some predetermined method, known to the mobile device 120, to derive the next set of keys. The node 110 will according to those embodiments make a similar refreshment of the shared cryptographic keys. Such key may sometimes also be referred to as a session key and may be used only one time in some embodiments, for enhanced security.

Thereby, the problem of regeneration of shared cryptographic keys in a coordinated manner may be solved. Also, by performing frequent regeneration of shared cryptographic keys, security is enhanced since using the same key for a large amount of data may make some cryptographic attacks easier.

According to some embodiments, the mobile device 120 may adapt the amount of data to be sent in the first training sequence, depending on specifics of the radio communication method, like the modulation scheme and the number of subcarriers. In general, the sequence of bits in the response to be sent back to the node 110 may be spread over different subcarriers. For example, in an embodiment the length of the response may be chosen to comprise 128 bits. Consider, next, a multi-carrier radio system with 640 subcarriers. When one training (pilot) symbol is transmitted on each subcarrier simultaneously, then the total number of bits in these simultaneous transmissions becomes 640 times the number of bits per training symbol. The latter may depend e.g. on the modulation order used. In this situation, there may be enough space to transmit the 128 bit response, if the modulation order is at least one fifth of a bit per training symbol.

Continuing with this example, the training sequence for each subcarrier may be e.g. 32 bits long, while each training symbol may comprise eight bits. Then, it would be required a sequence of four (pilot) symbols per subcarrier to transmit the whole training sequence. In this situation, there is more than enough space for the 128 bit response message. For instance, 128 subcarriers out of the 640 subcarriers may be selected, and the first bit (or, indeed, any agreed-on bit) of the training sequence in each of those subcarriers may be changed, so that these 128 bits constitute the response message to be sent to the node 110. This is schematically illustrated in FIG. 4, where pilot symbols of the first 128 subcarriers convey the response message sent by the mobile device 120.

Also, the response message may be divided into several parts and those parts may be transmitted separately, one-by-one in a series of training sequences by the mobile device 120. For example, the length of a training sequence in a radio system may be 26 bits (like in GSM) in some embodiments. In order to make the authentication secure, the length of the response message may be chosen to be 128 bits. Thus, a response cannot fit into a single training sequence as 128>26. However, according to an embodiment, the mobile device 120 may divide, i.e. fragment, the 128 bit response into five parts in such a manner that each part is at most 26 bits. (If needed, a part may be padded with bits known to both the node 110 and the mobile device 120, in order to make it as long as the training sequence. For example, those bits may be taken from the nonce.) Thereafter, the parts of the fragmented response may be transmitted as training sequences in five separate radio frames from the mobile device 120 to the node 110.

In this arbitrary example, the length of the MAC (128 bits) is not an integral multiple of the length of a training sequence (26 bits). So, there will be four MAC fragments of 26 bits each, and one shorter MAC fragment of 24 bits.

In some embodiments, the mobile device 120 may start, rather than end its sequence of fragmented transmissions with the shorter MAC 1 fragment, in case the MAC 1 is not a multiple of the training sequence. The reason is that when the last part (fragment) of the MAC 1 is very small, e.g. comprising only one bit, then an external observer may guess that last part, even before it has been sent by the mobile device 120. Since the observer has already seen the rest of the MAC 1, the observer may know or guess the whole MAC 1 before the mobile device 120 has finished transmitting the response message to the node 110. However, this situation may be countered by sending the smallest MAC 1 fragment first.

For instance, in case the last fragment of the MAC 1 comprises only one single bit, then an external observer would have a 50% chance of guessing it. But when the mobile device 120 starts with sending the fragment comprising only one bit of the MAC 1, then the external observer has no clue of what may come next.

Still, when the MAC is divided into several parts and those parts are transmitted separately, one-by-one in a series of training sequences, the external observer may guess the last part of the MAC (and thus know the whole MAC) with relatively high probability, after the mobile device 120 has transmitted the penultimate part of the MAC. As an example, the probability of this event is 1/(2²⁶), when the size of the last part of the MAC is 26 bits. For this reason, fragmenting the MAC 1 and sending those fragments in several training sequences may be less secure, than sending the (whole) MAC 1 in one training sequence.

According to some embodiments, the response message that the mobile device 120 transmits to the node 110 in response to the challenge, may be computed over the nonce, the ID of the node 110 and/or the ID of the mobile device 120 by the MAC algorithm. Further, according to some embodiments, a pre-processing may be made by applying a suitable mathematical function f { } to the ID of the node 110 and the ID of the mobile device 120, before applying the MAC algorithm over the pre-processed IDs and the nonce. Then the inputs to the MAC algorithm may be nonce, f (ID of the node 110, ID of the mobile device 120). Thereby processing time may be saved at the mobile side.

By using the training sequence that is transmitted by the mobile device 120 for the purpose of radio channel estimation, also for cryptographically authenticating the mobile device 120 towards the node 110, energy and time are saved. Thereby the training sequence becomes in itself a message that is part of a cryptographic authentication protocol running between the parties.

One advantage is a decrease in energy consumption of the mobile device 120, because it does not need to activate its transmission circuits separately for sending the authentication message. Another advantage is the saving in radio resources. Since the training sequence is “self-authenticating”, there is no need to allocate time and frequency for sending a separate authentication message from the mobile device 120 to the node 110. The threshold of when the savings becomes significant, depends on the specifics of the radio system, and on the communication pattern between the node 110 and the mobile device 120.

Here is an example of the latter dependency: the transmitter of the node 110 may have to be active when the mobile device 120 needs to transmit (any) data towards the node 110. Therefore, in situations when the mobile device 120 may need to transmit lots of data towards the node 110, or to the wireless communication network 100 via the node 110, embedding parts of authentication protocol in the training sequence may not seem to bring significant energy savings. However, when the mobile device 120 needs to transmit very little (or zero amount) of application data to the node 110, or to the wireless communication network 100 via the node 110, and the mobile device 120 yet need to authenticate itself to the node 110 for the purpose of receiving data, then embedding parts of authentication protocol in the training sequence may save energy.

The channel estimation and the authentication procedures may be combined in some embodiments, in order to coordinate their implementation.

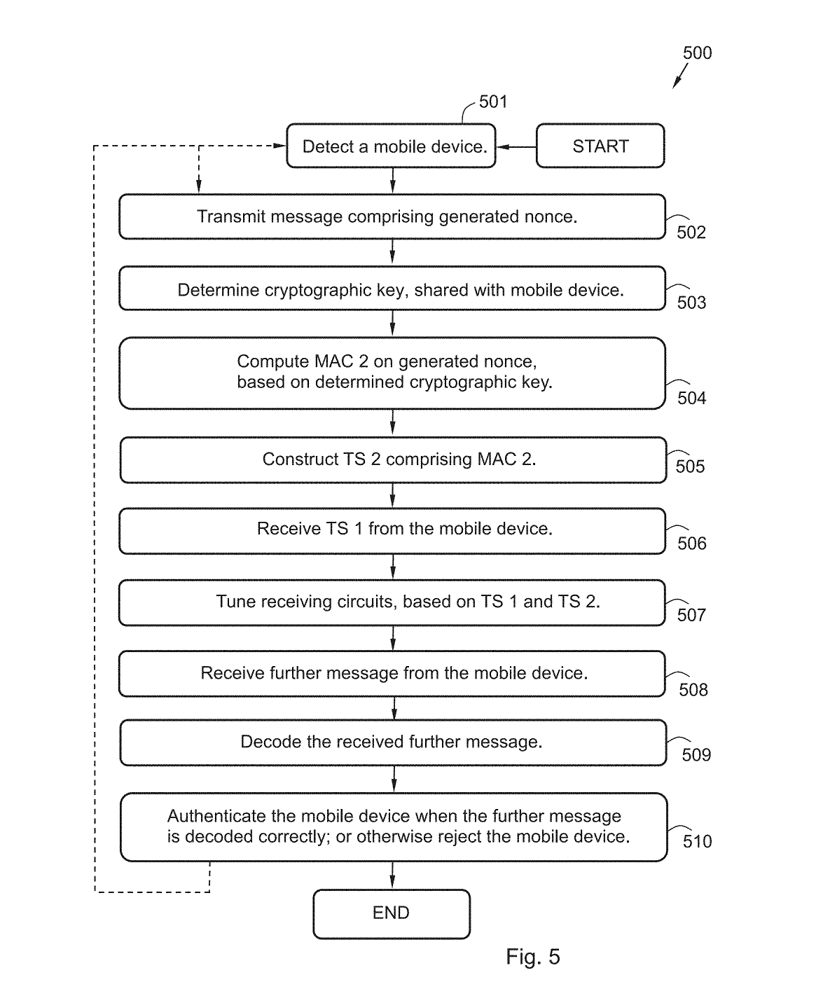

FIG. 5 is a flow chart illustrating embodiments of a method 500 for use in a node 110, for authenticating a mobile device 120 over an air interface. The node 110 may comprise a stationary radio network node in some embodiments, being part of a wireless communication network 100. For example, the node 110 may comprise an evolved NodeB (eNodeB) according to some embodiments. However, the node 110 may comprise a mobile station, cell phone or similar in some embodiments. The mobile device 120 may comprise e.g. a mobile station, cell phone or similar, or a wearable computing device, mobile sensor or similar. The wireless communication network 100 may be based on e.g. 3GPP LTE.

To appropriately authenticate the mobile device 120, the method 500 may comprise a number of actions 501-510. It is however to be noted that any, some or all of the described actions 501-510, may be performed in a somewhat different chronological order than the enumeration indicates. At least some of the actions 501-510 may be performed simultaneously or even be performed in an at least partly reversed order according to different embodiments. Further, it is to be noted that some actions may be performed in a plurality of alternative manners according to different embodiments, and that some such alternative manners may be performed only within some, but not necessarily all embodiments. Further, the authentication according to at least some of the performed actions 501-510 may be periodically repeated in some embodiments.

In Action 501, a mobile device 120 within radio signal range is detected.

Such detection may comprise detecting a discovery signal emitted by the mobile device 120. The emitted discovery signal may comprise an explicit or implicit identification reference of the mobile device 120.

The emitted discovery signal may be transmitted periodically with a predetermined or configurable time interval in some embodiments. However, the discovery signal transmission may be triggered by a trigger signal, previously transmitted by the node 110, e.g. at a periodic time interval.

According to Action 502, a message comprising a generated nonce is transmitted by the node 110, to be received by the mobile device 120.

The nonce may comprise a random number and may be generated e.g. by a pseudo-random generator, or extracted from a list of previously generated random numbers, to mention some possible examples of implementation.

In some embodiments, the transmitted message may comprise a node identification reference. Thereby, the receiving part, i.e. the mobile device 120, knows which cryptographic symmetric key to use.

In some embodiments the transmitted message may comprise a mobile device identification reference. Thereby, other devices may know that the message is intended for the mobile device 120 and may discard it, thereby saving processing power, time and energy.

Furthermore, the transmitted message may comprise an explicit or implicit request for authentication, in order for the receiving mobile device 120 to know what to do with the received challenge, in some embodiments.

In Action 503, a cryptographic key, which is shared with the detected 501 mobile device 120 is determined. In some embodiments, the cryptographic key may be extracted from a memory or database that may be comprised at the node 110, or be external to the node 110.

The shared cryptographic key may be a symmetric key, meaning that the same key is used both for encryption and decryption. The cryptographic key may be generated based on, or inspired by, a symmetric encryption algorithm such as e.g. Twofish, Serpent, Advanced Encryption Standard (AES), Blowfish, CASTS (CAST is mentioned after its creators Carlisle Adams and Stafford Taveres), RC4 (Rivest Cipher 4), Data Encryption Standard (DES), 3DES, Skipjack, Safer+/++, and/or International Data Encryption Algorithm (IDEA). These are merely some arbitrary examples of such algorithm.

The cryptographic key may be kept in a memory or database, associated with the other part, with which the cryptographic key is shared, i.e. the mobile device 120. Thus by entering the identification reference of the mobile device 120, received e.g. during action 501, into the data base, the associated cryptographic key, shared with the mobile device 120 may be extracted.

In some embodiments, the cryptographic key may be refreshed with a certain time interval, and/or each session, both at the node side and the mobile device side, for enhanced security. The node 110 may instruct the mobile device 120 to refresh cryptographic key to be used by the mobile device 120 for generating the first message authentication code, and also refresh cryptographic key to be used when generating the second message authentication code.

That is because a code cracker thereby will have less coded data with each encryption key to analyse. Also, in case the key is compromised, only messages transmitted during that particular session or within that limited time period may be decrypted by the third part having access to the compromised key.

Furthermore, in Action 504, a second message authentication code, or MAC 2, is computed on the generated nonce, based on the determined 503 cryptographic key.

In some embodiments, the second message authentication code may be computed on the generated nonce, the node identification reference and/or a mobile device identification reference.

In Action 505, a second training sequence comprising the second message authentication code is constructed.

In some embodiments, the second training sequence may consist of the second message authentication code. However, in other embodiments, the second training sequence may comprise a part of the second message authentication code, e.g. in case the second message authentication code is longer than the second training sequence. In such case the second message authentication code may be truncated, or otherwise shortened by a function in order to fit into the training sequence length. Then, another training sequence may be transmitted, comprising the second part of the MAC, and so on, until all parts of the MAC have been used in this manner.

According to some embodiments, constructing the training sequence may comprise inserting parts of the second message authentication code into predefined positions in the second training sequence.

In Action 506, a first training sequence is received from the mobile device 120, comprising a first message authentication code.

In some embodiments, the first training sequence comprising the first message authentication code may be received over at least two (subsequent) communication frames.

Action 507 comprises tuning the receiving circuits of the receiver 610, based on the received 506 first training sequence and the locally constructed 505 second training sequence.

Thus the received 506 first message authentication code comprised in the first training sequence may be utilised for radio channel estimation of the mobile device 120. Thereby, the channel may be estimated at least partly based on the received 506 first training sequence and the constructed 505 second training sequence when the two training sequences are fed to the channel estimation.

The tuning of the receiving circuits of the receiver 610 may comprise a channel estimation based on the received first training sequence and the locally constructed second training sequence, e.g. using the adaptive equaliser 300 shown in FIG. 3.

Action 508 comprises receiving a further message from the mobile device 120. The received further message may comprise data to be transmitted from the mobile device 120 to the node 110.

Furthermore, Action 509 comprises decoding the further message received 508 from the mobile device 120.

Action 510 comprises authenticating the mobile device 120 when the further message is decoded 509 correctly, otherwise rejecting the mobile device 120.

Thereby, the mobile device 120 may be authenticated when the computed 504 second message authentication code corresponds to the received 506 first message authentication code, as only in this case the channel estimation/the tuning of the receiving circuits was successful and a successful decoding of the further message was possible. If the two message authentication codes do not correspond to each other, the channel estimation/the tuning of the receiving circuits does not correspond the actual channel and the decoding of the further message fails as well as the authentication of the mobile device 120. Hence, the authentication of the mobile device 120 is only finished after the further message was decoded correctly by the node 110.

When the computed 504 second message authentication code does not correspond to the received 506 first message authentication code (i.e. the further message could not be correctly decoded), the mobile device 120 may be rejected. Possibly, in case of rejection according to some embodiments, a new nonce may be generated and a new challenge transmitted. The reason why the mobile device 120 may fail to present a correct message authentication code may be that the channel is bad and/or the challenge message is distorted before reaching the mobile device 120. In such case, repeating the authentication process for a predetermined number of times may be beneficial.

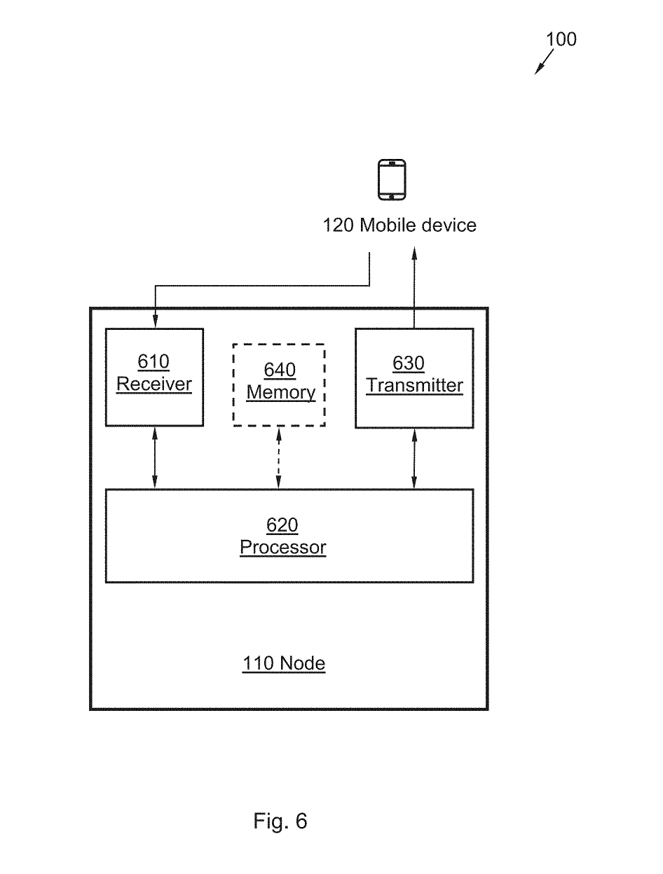

FIG. 6 illustrates an embodiment of a node 110, configured for wireless communication in a wireless communication network 100. The node 110 is further configured for performing the method 500 according to at least some of the previously described actions 501-510 for authenticating a mobile device 120 over a wireless communication interface. In some embodiments, the authentication of the mobile device 120 may be periodically repeated.

The node 110 may comprise a stationary radio network node in some embodiments, being part of a wireless communication network 100. For example, the node 110 may comprise an evolved NodeB (eNodeB) according to some embodiments. However, the node 110 may comprise a mobile station, cell phone or similar in some embodiments. The mobile device 120 may comprise e.g. a mobile station, cell phone or similar, or a wearable computing device, mobile sensor or similar. The wireless communication network 100 may be based on e.g. 3GPP LTE.

For enhanced clarity, any internal electronics or other components of the node 110, not completely indispensable for understanding the herein described embodiments have been omitted from FIG. 6.

The node 110 comprises a receiver 610, configured to receive a wireless signal comprising an identification reference to the mobile device 120. The receiver 610 is also configured to receive a first training sequence comprising a first message authentication code from the mobile device 120. Further, the receiver 610 is configured to tune the receiving circuits, based on the received first training sequence and the locally constructed second training sequence.

The receiver 610 is further configured to receive a further message from the mobile device 120 after tuning the receiving circuits of the receiver 610.

In some embodiments, the receiver 610 may be configured to receive two or more first training sequences comprising the first message authentication code distributed over at least two communication frames.

Further, the node 110 may comprise a processor 620, configured to detect the mobile device 120. The processor 620 is also configured to generate the nonce to be transmitted. Also, the processor 620 is further configured to generate a nonce; to determine a cryptographic key which is shared with the mobile device 120 and to compute a first message authentication code based on the generated nonce and the cryptographic key. The processor 620 is also configured to construct a second training sequence comprising the second message authentication code.

The processor 620 is further configured to decode the further message and to authenticate the mobile device 120 when the further message is decoded correctly, otherwise reject the mobile device 120.

The processor 620 may be configured to utilise the received first message authentication code comprised in the training sequence for radio channel estimation of the mobile device 120 in some embodiments.

Further, the processor 620 may be further configured detect a mobile device identification reference of the mobile device 120 and to compute the second message authentication code based on the generated nonce, the node identification reference and the mobile device identification reference, according to some embodiments.

The processor 620 may be configured to perform a channel estimation based on the received first training sequence and the locally constructed second training sequence and wherein the receiver 610 may be configured to tune the receiving circuits based on the channel estimation, in some embodiments.

According to some embodiments, the processor 620 may be configured to compute the second message authentication code on the generated nonce, the node identification reference and a mobile device identification reference.

The processor 620 may be configured to periodically repeat the authentication of the mobile device 120.

The processor 620 may further be configured to instruct the mobile device 120 to refresh cryptographic key to be used by the mobile device 120 for generating the first message authentication code, and may also be configured to refresh cryptographic key to be used when generating the second message authentication code.

Such processor 620 may comprise one or more instances of a processing circuit, i.e. a Central Processing Unit (CPU), a processing unit, a processing circuit, a processor, an Application Specific Integrated Circuit (ASIC), a microprocessor, or other processing logic that may interpret and execute instructions. The herein utilised expression “processor” may thus represent a processing circuitry comprising a plurality of processing circuits, such as, e.g., any, some or all of the ones enumerated above.

In further addition, the node 110 comprises a transmitter 630, configured to transmit a message comprising a generated nonce to be received by the mobile device 120.

In some embodiments, the transmitter 630 may further be configured to transmit a node identification reference of the node 110 to the mobile device 120. Furthermore, the transmitter 630 may also be configured to transmit a mobile device identification reference in association with transmission of a message to be received by the mobile device 120.

Furthermore, the node 110 may further comprise at least one memory 640, according to some embodiments. The optional memory 640 may comprise a physical device utilised to store data or programs, i.e., sequences of instructions, on a temporary or permanent basis. According to some embodiments, the memory 640 may comprise integrated circuits comprising silicon-based transistors. Further, the memory 640 may be volatile or non-volatile. The memory may store e.g. a set of cryptographic keys, associated with other entities such as the mobile device 120, such that it is enabled to extract the cryptographic key shared with the mobile device 120, by entering an identity of mobile device 120 in some embodiments.

The above described actions 501-510 to be performed in the node 110 may be implemented through the one or more processors 620 in the node 110, together with computer program product for performing at least some of the functions of the actions 501-510. Thus a computer program comprising program code may perform a method 500 according to any, at least some, or all of the functions of the actions 501-510 for authenticating the mobile device 120, when the computer program is loaded into the processor 620 of the node 110.

Further, a computer program product may comprise a computer readable storage medium storing program code thereon for use by a node 110, for authenticating the mobile device 120, wherein the program code comprising instructions for executing the method 500 comprising: detecting 501 a mobile device 120; transmitting 502 a message comprising a generated nonce; determining 503 a cryptographic key, which is shared with the detected 501 mobile device 120; computing 504 a second message authentication code, based on the generated nonce and the determined 503 cryptographic key; constructing 505 a second training sequence comprising the second message authentication code; receiving 506 a first training sequence from the mobile device 120, comprising a first message authentication code; tuning 507 the receiving circuits of the receiver 610, based on the received 506 first training sequence and the constructed 505 second training sequence; receiving 508 a further message from the mobile device 120; decoding 509 the further message received 508 from the mobile device 120; and authenticating 510 the mobile device 120 when the further message is decoded 509 correctly, otherwise rejecting the mobile device 120.

The computer program product mentioned above may be provided for instance in the form of a data carrier carrying computer program code for performing at least some of the actions 501-510 according to some embodiments when being loaded into the processor 620. The data carrier may be, e.g., a hard disk, a CD ROM disc, a memory stick, an optical storage device, a magnetic storage device or any other appropriate medium such as a disk or tape that may hold machine readable data in a non-transitory manner. The computer program product may furthermore be provided as computer program code on a server and downloaded to the node 110 remotely, e.g., over an Internet or an intranet connection.

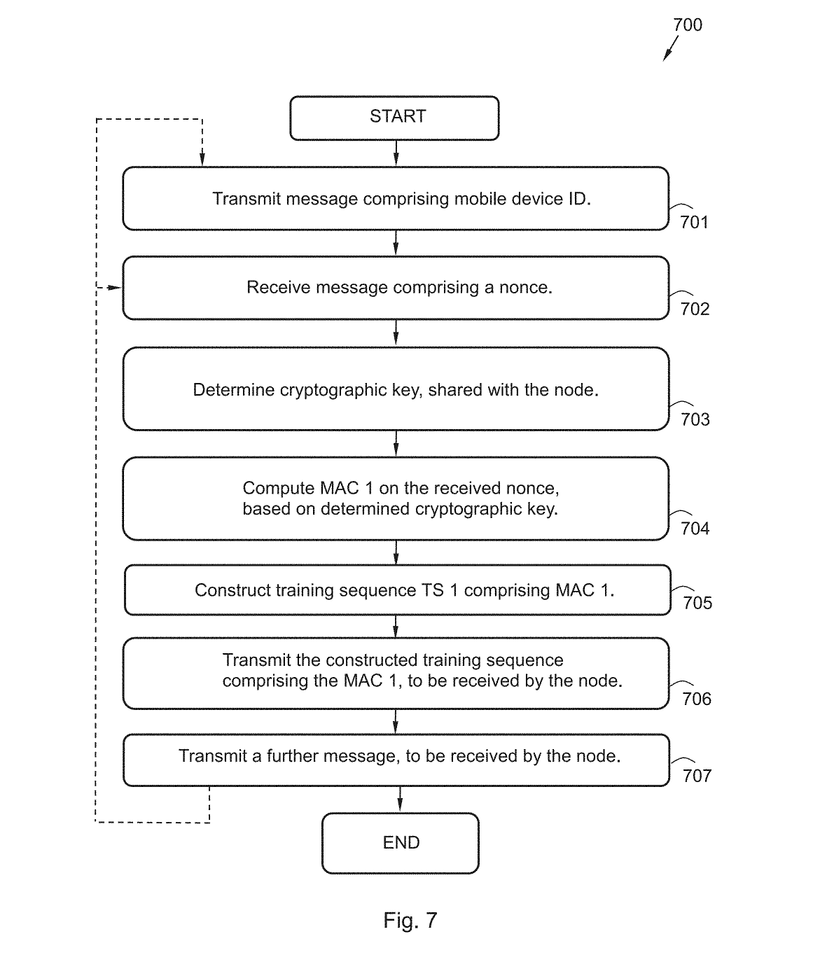

FIG. 7 is a flow chart illustrating embodiments of a method 700 for use in a mobile device 120 for providing authentication of the mobile device 120 to a node 110 over an air interface i.e. via a wireless communication interface.

The node 110 may comprise a stationary radio network node in some embodiments, being part of a wireless communication network 100. For example, the node 110 may comprise an evolved NodeB (eNodeB) according to some embodiments. However, the node 110 may comprise a mobile station, cell phone or similar in some embodiments. The mobile device 120 may comprise e.g. a mobile station, cell phone or similar, or a wearable computing device, mobile sensor or similar. The wireless communication network 100 may be based on e.g. 3GPP LTE.

To appropriately provide authentication of the mobile device 120 to the node 110, the method 700 may comprise a number of actions 701-707.

It is however to be noted that any, some or all of the described actions 701-707, may be performed in a somewhat different chronological order than the enumeration indicates, be performed simultaneously or even be performed in an at least partly reversed order according to different embodiments. Further, it is to be noted that some actions may be performed in a plurality of alternative manners according to different embodiments, and that some such alternative manners may be performed only within some, but not necessarily all embodiments. The authentication according to at least some of the performed actions 701-707 may be periodically repeated according to some embodiments. The method 700 may comprise the following actions:

According to Action 701, a message comprising a mobile device identity reference is transmitted. The transmitted message may be repeatedly transmitted in some embodiment with a certain periodicity. In some embodiments, the message transmission may be triggered by a trigger signal, previously received from the node 110.

Action 702 comprises receiving a message comprising a nonce, from the node 110. The message may in some embodiments comprise a node identity reference and/or a mobile device identity reference. Furthermore, the message may comprise, in some embodiments, an instruction or information that the node 110 expect the mobile device 120 to respond with a response message according to the method 700.

Action 703 comprises determining a cryptographic key, which is shared with the node 110.

The cryptographic key, which is shared with the node 110 may be extracted from a memory e.g. a data base. In an embodiment, the node identity reference may be used for extracting the cryptographic key shared with the node 110.

In some embodiments, the cryptographic key to be used for generating the first message authentication code may be refreshed upon receiving an instruction to refresh cryptographic key from the node 110.

In Action 704 a message authentication code is computed based on the received nonce and on the determined 703 cryptographic key.

According to some embodiments, the message authentication code may be computed on the received nonce, the node identification reference and the mobile device identification reference.

Action 705 comprises constructing a first training sequence, TS1, which first training sequence in turn comprises the computed 704 first message authentication code, MAC 1.

Furthermore, the first message authentication code may be divided into a plurality of separate parts when the length of the first message authentication code exceeds the length of the first training sequence in some embodiments. Further, in such embodiments, the separate parts of the first message authentication code may be distributed over at least two communication frames.

According to Action 706, the constructed 705 first training sequence is transmitted, to be received by the node 110.

In some embodiments, wherein the first message authentication code has been divided into a plurality of separate parts, the two or more first training sequences may be transmitted in at least two communication frames.

Action 707 comprises transmitting a further message to the node 110. In some embodiments, the further message is transmitted when a time period has passed from the moment when the training sequence has been transmitted in action 706.

Thereby a response message has been sent by the mobile device 120, responding to the challenge received from the node 110.

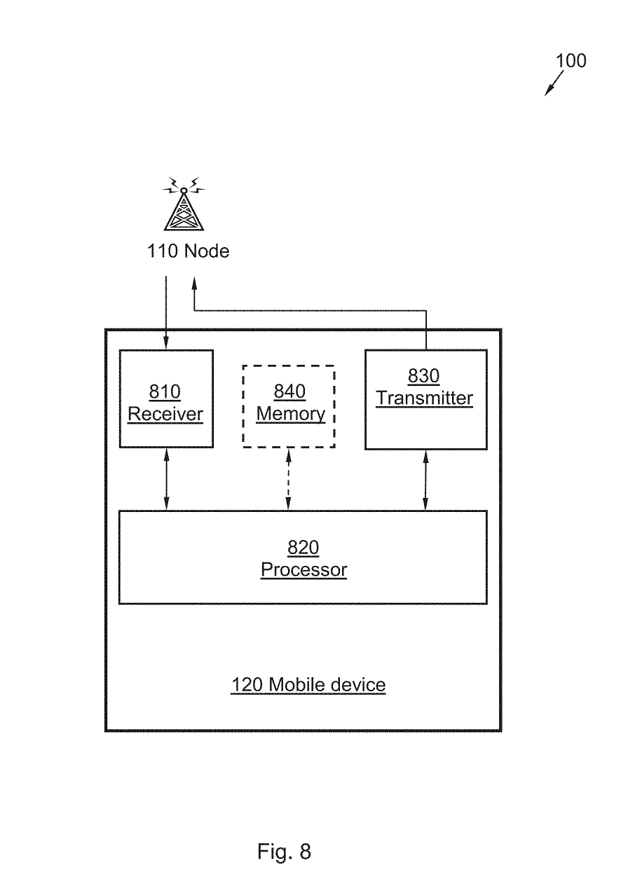

FIG. 8 illustrates an embodiment of a mobile device 120, configured to provide authentication of the mobile device 120 to a node 110 over a wireless communication interface by performing the method 700 according to at least some of the previously described actions 701-707. In some embodiments, the provision of authentication of the mobile device 120 may be periodically repeated.

The node 110 may comprise a stationary radio network node in some embodiments, being part of a wireless communication network 100. For example, the node 110 may comprise an evolved NodeB (eNodeB) according to some embodiments. However, the node 110 may comprise a mobile station, cell phone or similar in some embodiments. The mobile device 120 may comprise e.g. a mobile station, cell phone or similar, or a wearable computing device, mobile sensor or similar. The wireless communication network 100 may be based on e.g. 3GPP LTE.

For enhanced clarity, any internal electronics or other components of the mobile device 120, not completely indispensable for understanding the herein described embodiments have been omitted from FIG. 8.

The mobile station 120 comprises a receiver 810 configured to receive a message comprising a nonce, from the node 110. However, the receiver 810 may further be configured to receive the message comprising a node identity reference and/or mobile device identity reference in addition to the nonce.

The receiver 810 may be configured for receiving radio signals over a wireless interface. The signals may be received from, e.g., the node 110, or any other entity configured for communication within the wireless communication network 100, according to some embodiments.

In addition, the mobile device 120 also comprises a processor 820, configured to determine a cryptographic key, which is shared with the node 110. The processor 820 is also configured to compute a first message authentication code based on the received nonce and on the determined cryptographic key. In addition the processor 820 is further configured to construct a first training sequence comprising the computed first message authentication code.

In some embodiments, the processor 820 may be configured to compute the first message authentication code based on the received nonce, the node identification reference and/or the mobile device identification reference.

In some additional embodiments, the processor 820 may also be configured to divide the first message authentication code into a plurality of separate parts and embed them into the first training sequence before transmission.

Thus the processor 820 may be configured to divide the first message authentication code into a plurality of separate parts when the length of the first message authentication code exceeds the length of the first training sequence. The processor 820 may also be configured to distribute the separate parts of the first message authentication code over at least two communication frames in such embodiments.

The processor 820 may further be configured to distribute the divided first message authentication code by not putting the shortest of the separate parts in the ending communication frame of the at least two communication frames. In other words, the processor 820 may be configured to put the shortest of the separate pats in a communication frame which is not the last one (i.e. is different from the last one) sent of the at least two communications frames.

According to some embodiments, the processor 820 may be further configured to refresh cryptographic key to be used for generating the first message authentication code, upon receiving an instruction to refresh cryptographic key from the node 110.

Such processor 820 may comprise one or more instances of a processing circuit, i.e. a Central Processing Unit (CPU), a processing unit, a processing circuit, a processor, an Application Specific Integrated Circuit (ASIC), a microprocessor, or other processing logic that may interpret and execute instructions. The herein utilised expression “processor” may thus represent a processing circuitry comprising a plurality of processing circuits, such as, e.g., any, some or all of the ones enumerated above.

In addition, the mobile device 120 also comprises a transmitter 830 configured to transmit a message comprising an identity reference to the mobile device 120. Also, the transmitter 830 is configured to transmit a message comprising a first training sequence to the node 110 and to subsequently transmit a further message to the node 110. In some embodiments, the transmitter 830 may transmit the message comprising two or more first training sequences to the node 110 over a plurality of communication frames.

Furthermore, the mobile device 120 may further comprise at least one memory 840, according to some embodiments. The optional memory 840 may comprise a physical device utilised to store data or programs, i.e., sequences of instructions, on a temporary or permanent basis. According to some embodiments, the memory 840 may comprise integrated circuits comprising silicon-based transistors. Further, the memory 840 may be volatile or non-volatile.

The above described actions 701-707 to be performed in the mobile device 120 may be implemented through the one or more processors 820 in the mobile device 120, together with computer program product for performing at least some of the functions of the actions 701-707. Thus a computer program product, comprising instructions for performing the actions 701-707 in the mobile device 120 may perform a method 700 comprising at least some of the method actions 701-707, for providing authentication to the node 110 when the computer program is loaded into the processor 820 of the mobile device 120.

Thus a computer program product comprising a computer readable storage medium storing program code thereon for use by a mobile device 120 for transmitting 701 a message comprising a mobile device identity reference; receiving 702 a message comprising a nonce, from the node 110; determining 703 a cryptographic key, which is shared with the node 110; computing 704 a first message authentication code, based on the received nonce and on the determined 703 cryptographic key; constructing 705 a first training sequence comprising the computed 704 message authentication code; transmitting 706 the constructed 705 first training sequence, to be received by the node 110; and transmitting 707 a further message to the node 110.

The computer program product mentioned above may be provided for instance in the form of a data carrier carrying computer program code for performing at least some of the actions 701-707 according to some embodiments when being loaded into the processor 820 of the mobile device 120. The data carrier may be, e.g., a hard disk, a CD ROM disc, a memory stick, an optical storage device, a magnetic storage device or any other appropriate medium such as a disk or tape that may hold machine readable data in a non-transitory manner. The computer program product may furthermore be provided as computer program code on a server and downloaded to the mobile device 120 remotely, e.g., over an Internet or an intranet connection.

The terminology used in the description of the embodiments as illustrated in the accompanying drawings is not intended to be limiting of the described methods 500, 700; the node 110 and/or the mobile device 120. Various changes, substitutions and/or alterations may be made, without departing from the invention as defined by the appended claims.

As used herein, the term “and/or” comprises any and all combinations of one or more of the associated listed items. The term “or” as used herein, is to be interpreted as a mathematical OR, i.e., as an inclusive disjunction; not as a mathematical exclusive OR (XOR), unless expressly stated otherwise. In addition, the singular forms “a”, “an” and “the” are to be interpreted as “at least one”, thus also possibly comprising a plurality of entities of the same kind, unless expressly stated otherwise. It will be further understood that the terms “includes”, “comprises”, “including” and/or “comprising”, specifies the presence of stated features, actions, integers, steps, operations, elements, and/or components, but do not preclude the presence or addition of one or more other features, actions, integers, steps, operations, elements, components, and/or groups thereof. A single unit such as e.g. a processor may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms such as via Internet or other wired or wireless communication system.

What is claimed is:

1. A node, for authenticating a mobile device over an air interface, the node comprising:
a transmitter;
a processor; and
a receiver;
wherein the processor is configured to detect the mobile device, to generate a nonce, to determine a cryptographic key which is shared with the mobile device and to compute a second message authentication code based on the generated nonce and the cryptographic key, and to construct a second training sequence comprising the second message authentication code;
wherein the transmitter is configured to transmit the generated nonce to the mobile device;
wherein the receiver is configured to:
receive a first training sequence comprising a first message authentication code from the mobile device and to tune receiving circuits of the receiver, based on the received first training sequence and the constructed second training sequence, and
receive a further message from the mobile device after tuning the receiving circuits of the receiver;
wherein the processor is further configured to decode the further message and to authenticate the mobile device when the further message is decoded correctly, otherwise reject the mobile device.

2. The node according to claim 1, wherein the processor is configured to perform a channel estimation based on the received first training sequence and the constructed second training sequence, and wherein the receiver is configured to tune the receiving circuits based on the channel estimation.

3. The node according to claim 1, wherein the processor is configured to periodically repeat the authentication of the mobile device.

4. The node according to claim 1, wherein the transmitter is further configured to transmit a node identification reference of the node to the mobile device.

5. The node according to claim 1, wherein the processor is further configured detect a mobile device identification reference of the mobile device and to compute the second message authentication code based on the generated nonce, the node identification reference, and the mobile device identification reference.

6. The node according to claim 1, wherein the receiver is configured to receive two or more of the first training sequences comprising the first message authentication code, distributed over at least two communication frames.

7. The node according to claim 1, wherein the processor is further configured to instruct the mobile device to refresh a cryptographic key to be used by the mobile device for generating the first message authentication code, and also configured to refresh the cryptographic key to be used when generating the second message authentication code.

8. The node according to claim 1, further comprising an adaptive equaliser with a cryptographic protocol module and a training sequence generator, wherein the training sequence generator may take a part, or all of its input from the cryptographic protocol module for constructing the second training sequence.

9. A method in a node, for authenticating a mobile device over an air interface, the method comprising:
detecting a mobile device;
transmitting a message comprising a generated nonce;
determining a cryptographic key, which is shared with the detected mobile device;
computing a second message authentication code, based on the generated nonce and the determined cryptographic key;
constructing a second training sequence comprising the second message authentication code;
receiving a first training sequence from the mobile device, the first training sequence comprising a first message authentication code;
tuning receiving circuits of the receiver, based on the received first training sequence and the constructed second training sequence;
receiving a further message from the mobile device;
decoding the further message received from the mobile device; and
authenticating the mobile device when the further message is decoded correctly, otherwise rejecting the mobile device.

10. A mobile device, comprising:
a receiver configured to receive a message comprising a nonce, from a node;
a processor, configured to determine a cryptographic key, which is shared with the node, to compute a first message authentication code based on the received nonce and on the determined cryptographic key and to construct a first training sequence comprising the computed first message authentication code; and
a transmitter configured to transmit the first training sequence to the node and to subsequently transmit a further message to the node.

11. The mobile device according to claim 10, wherein the message received from the node comprises the nonce, a node identification reference and a mobile device identification reference, and wherein the processor is configured to compute the first message authentication code based on the received nonce, the node identification reference and the mobile device identification reference.

12. The mobile device according to claim 10, wherein the processor is configured to divide the first message authentication code into a plurality of separate parts when the length of the first message authentication code exceeds the length of the first training sequence and distribute the separate parts of the first message authentication code over at least two communication frames.

13. The mobile device according to claim 12, wherein the processor is further configured to distribute the divided first message authentication code by putting a shortest of the separate parts in a communication frame being different from an ending communication frame of the at least two communication frames.

14. The mobile device according to claim 10, wherein the processor is further configured to refresh a cryptographic key to be used for generating the first message authentication code, upon receiving an instruction to refresh the cryptographic key from the node.

15. A method in a mobile device, for providing authentication of the mobile device to a node over an air interface, the method comprising:
transmitting a message comprising a mobile device identity reference;
receiving a message comprising a nonce, from the node;
determining a cryptographic key, which is shared with the node;
computing a first message authentication code, based on the received nonce and on the determined cryptographic key;
constructing a first training sequence comprising the computed first message authentication code;
transmitting the constructed first training sequence, to be received by the node; and
transmitting a further message to the node.
